(19) United States
(12) Patent Application Publication
(10) Pub. No.: US 2011/0100102 A1
(43) Pub. Date: May 5, 2011

(54) QUICK CONVERSION GUIDE

(76) Inventor: Kota J. Reddy, Houston, TX (US)

(21) Appl. No.: 12/913,315

(22) Filed: Oct. 27, 2010

Related U.S. Application Data
(60) Provisional application No. 61/256,801, filed on Oct. 30, 2009.

(51) Int. Cl. G01N 1/00

(52) U.S. Cl. 73/64.56

(57) ABSTRACT

Embodiments of the invention include a quick conversion guide including a housing having a plurality of openings disposed through the housing; and an insert having a first measurement range, a second measurement range, and an indication range provided on a surface of the insert. The insert may be disposed in the housing such that a first measurement from the first range, a second measurement from the second range, and an indicator from the indication range are simultaneously viewable through the plurality of openings. Embodiments of the invention include a method of calculating a blood sugar level using a conversion guide including locating a hemoglobin A1c value on an insert disposed in a housing of the conversion guide; displaying the hemoglobin A1c value in a first window of the housing; and displaying a blood sugar value in a second window of the housing simultaneously with the hemoglobin A1c value. The blood sugar value may be a calculated value based on the hemoglobin A1c value.

### CROSS-REFERENCE TO RELATED APPLICATIONS

This application claims benefit of U.S. Provisional Patent Application Ser. No. 61/256,801, filed Oct. 30, 2009, which is herein incorporated by reference in its entirety.

### BACKGROUND OF THE INVENTION

1. Field of the Invention

Embodiments of the invention relate to an apparatus and method of use regarding an individual's hemoglobin A1c level and their blood sugar level. Embodiments of the invention relate to a quick conversion guide that is easy to use and provides an individual's average blood sugar level and one or more health level warnings associated with the blood sugar level, based on their hemoglobin A1c level. Embodiments of the invention relate to methods of using a conversion guide to quickly obtain information regarding an individual's blood sugar level and a warning about the status of their health, based on their hemoglobin A1c level.

2. Description of the Related Art

Hemoglobin is a substance within an individual's red blood cells that carries oxygen throughout the body. In the normal life span of a red blood cell, glucose molecules in the individual's body may react with the hemoglobin. When the individual's blood sugar concentration is too high, sugar builds up in their blood and combines with the hemoglobin, thereby forming “glycated” hemoglobin. Glycated hemoglobin is also referred to as glycohemoglobin, glycosylated hemoglobin, and hemoglobin A1c (“HA1c” or “HbA1c”).

When a hemoglobin molecule is glycated, the hemoglobin molecule remains combined with the glucose molecule for the duration of the red blood cell life span. A buildup of glycated hemoglobin within an individual's red blood cells generally reflects the average level of glucose that the cells have been exposed to during their life cycle. The average amount of glucose in the individual's blood can therefore be determined by measuring their hemoglobin A1c level.

The failure to maintain a glucose level, i.e. blood sugar level, within a normal range can lead to various health complications, including damage to the eye, kidneys, and nerves. Individuals who are diabetic are particularly susceptible to developing a high glucose level without the proper diet, medication, and treatment. Studies have shown that for every one percent reduction of hemoglobin A1c in an individual, there is a ten percent decrease in the risk that that individual will suffer from a health complication. It is thus important to regularly monitor and control glucose levels in our bodies. By measuring the individual's hemoglobin A1c level on a regular basis, one can also assess the effectiveness of any treatment or therapy directed at regulating their glucose level.

Therefore, there is a need for an improved method and apparatus to facilitate obtaining and monitoring an individual's glucose level. There is also a need for an improved method and apparatus to help quickly correlate the individual's hemoglobin A1c level to their glucose level. There is a further need for an improved method and apparatus that the individual can easily use and understand to obtain information regarding their glucose level and the status of their health.

### SUMMARY OF THE INVENTION

Embodiments of the invention include a quick conversion guide. The guide may include a housing having a plurality of openings disposed through the housing. The guide may also include an insert having a first measurement range, a second measurement range, and an indication range provided on a surface of the insert. The insert may be disposed in the housing such that a first measurement from the first range, a second measurement from the second range, and an indicator from the indication range are simultaneously viewable through the plurality of openings.

Embodiments of the invention include a method of calculating a blood sugar level using a conversion guide. The method may include locating a hemoglobin A1c value on an insert disposed in a housing of the conversion guide. The method may also include displaying the hemoglobin A1c value in a first window of the housing. The method may further include displaying a blood sugar value in a second window of the housing simultaneously with the hemoglobin A1c value. The blood sugar value may be a calculated value based on the hemoglobin A1c value.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top view of a conversion guide according to one embodiment of the invention.

FIG. 2 is a top view of the conversion guide according to one embodiment of the invention.

### DETAILED DESCRIPTION

The amount of hemoglobin A1c in an individual's body may be correlated to that individual's glucose level, also know as blood sugar level. In particular, the level of hemoglobin A1c in the individual's body can be used to calculate their average blood sugar level over the past three months (from the time of the hemoglobin A1c measurement). An individual's hemoglobin A1c level can range from about 4 percent to about 13.5 percent and their average glucose level can range from about 65 mg/dL to about 403 mg/dL. The level of hemoglobin A1c may be determined from a blood sample.

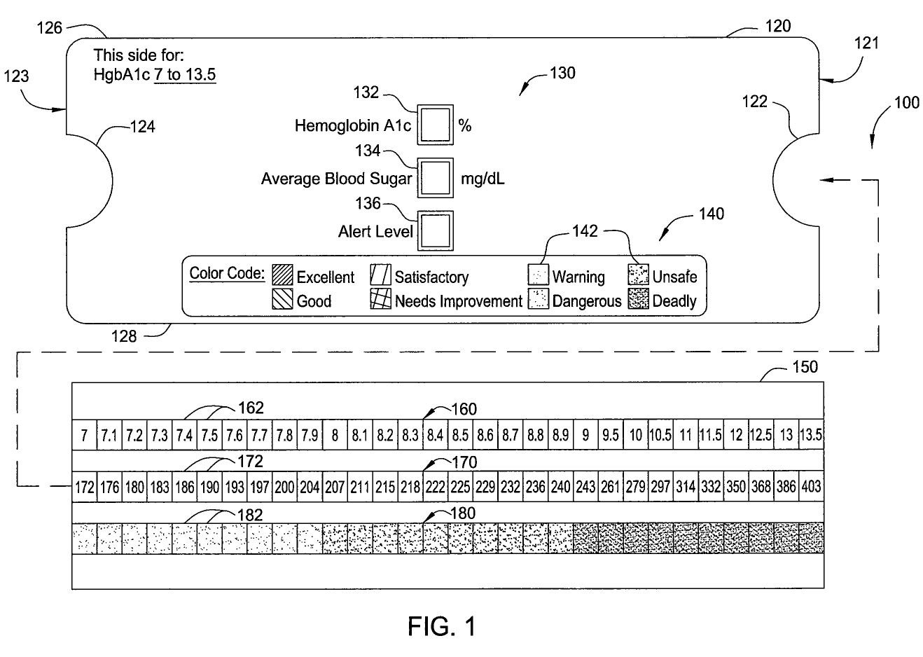

FIG. 1 illustrates a top view of a conversion guide 100 according to one embodiment. The conversion guide 100 includes a housing 120 and an insert 150. The housing 120 may be formed from at least two sheets of material that are connected together along their upper and lower edges 126 and 128, thereby forming openings 121 and 123 along the right and left sides 122 and 124. In one embodiment, the housing 120 may be formed from substantially rectangular-shaped sheets of material.

The housing 120 includes a first display feature 130 having at least a first aperture 132, a second aperture 134, and a third aperture 136 each disposed through the body of the housing 120. In one embodiment, the apertures are substantially square-shaped. The first display feature 130 is configured to display and identify one or more measurements and indicators provided on the insert 150 as further described below. In one embodiment, the first aperture 132 may be provided to display a hemoglobin A1c percentage that can be correlated to an average blood sugar level. In one embodiment, the second aperture 134 may be provided to display an average blood sugar level that can be correlated to an alert level. In one embodiment, the third aperture 136 may be provided to display an alert level, such as a color indicator that can be correlated to a health level warning.

The housing 120 may include a second display feature 140 that provides a plurality of color indications and health level warnings 142. In one embodiment, the second display feature 140 may include a color coded chart provided on the outer surface of the housing 120 that displays a plurality of health level warnings. Each health level warning is identified with a color indication. In one embodiment, the second display feature 140 includes eight health level warnings and each health level warning is associated with a color indication. The health level warnings may include at least one of excellent, good, satisfactory, needs improvement, warning, dangerous, unsafe, and deadly. The color indications may include at least one of dark green, green, light green, yellow, light orange, dark orange, red, and brown.

The insert 150 is configured to be insertable into the housing 120 through the openings 121 and 123. The insert 150 may be formed from a sheet of material configured to be easily insertable into, slideable within, and removable from the housing 120. In one embodiment, the insert 150 may be formed from a substantially rectangular-shaped sheet of material. The right and left edges 122 and 124 may include semi-circular recesses so that the insert 150 is readily accessible to the user at all times during use of the conversion guide 100.

The insert 150 includes a first measurement range 160, a second measurement range 170, and an indication range 180. The first measurement range 160 may include an incremental range of numbers 162 provided in a row on the outer surface of the insert 150. The range of numbers 162 may be provided in increments of 0.1, from 4 to 6.9 on a first side of the insert 150 and from 7 to 13.5 on the opposite side of the insert 150. The first measurement range 160 may include the hemoglobin A1c level values that may be generated in an individual's body.

The second measurement range 170 may include an incremental range of numbers 172 provided in a row on the outer surface of the insert 150, below the first measurement range 160. The range of numbers 172 may be provided in increments of 3 to 4, from 65 to 168 on a first side of the insert 150 and from 172 to 403 on the opposite side of the insert 150. The second measurement range 170 may include the average blood sugar level values that may be generated in an individual's body. The second measurement range 170 may be the calculated average blood sugar level values based on the hemoglobin A1c level values of the first measurement range 160.

The indication range 180 may include a range of colors indicators 182 provided in a row on the outer surface of the insert 150, below the second measurement range 170. The color indicators 182 may be provided in increments of color ranges including dark green, green, light green, yellow, light orange, and dark orange on a first side of the insert 150 and red and brown on the opposite side of the insert 150. The values provided in the first and second measurement ranges 160 and 170 may each be assigned a color indicator 182, which may be correlated to the indications and health level warnings 142 provided on the housing 120.

In one embodiment, the insert 150 may be inserted into the housing 120. When the insert 150 is located in the housing 120, the values in the first measurement range 160 may be displayed and viewed through the first aperture 132; the values in the second measurement range 170 may be displayed and viewed through the second aperture 134; and the colors indicators in the indication range 180 may be displayed and viewed through the third aperture 136. The values and color indicators provided on the insert 150 are aligned in a manner that when a value provided in the first measurement range 160 is displayed in the first aperture 132, the corresponding correlated value and color indicator are each simultaneously displayed in the remaining apertures, respectively.

In one embodiment, an individual's hemoglobin A1c level may be obtained from a simple blood test or in any other manner known by one of ordinary skill in the art. A user of the conversion guide 100 may move the insert 150 within the housing 120 until the particular hemoglobin A1c level is displayed in the first aperture 132. Once the hemoglobin A1c level is shown, the insert 150 is configured to simultaneously display the correlated average blood sugar level (based on the hemoglobin A1c value) in the second aperture 134. The insert 150 is also configured to simultaneously display the corresponding color indicator (that is assigned to the displayed hemoglobin A1c and blood sugar values) in the third aperture 136. The color indicator (or alert level) displayed in the third aperture 138 corresponds to one of the health level warnings 142 provided on the surface of the housing 120. Based on their hemoglobin A1c level, the user can immediately obtain their average blood sugar level and a warning about the status of their health using the conversion guide 100. Depending on the status of their health provided by the health level warning, the user may then take any appropriate measures to obtain proper treatment.

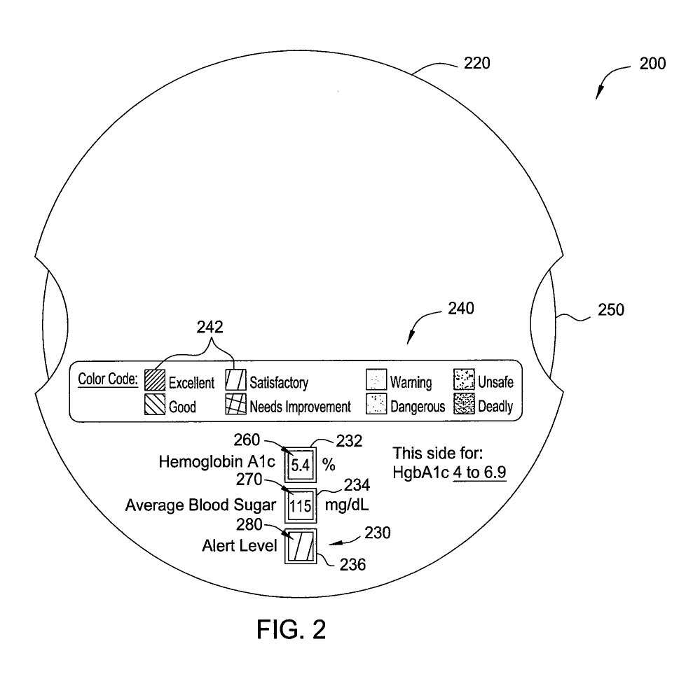

FIG. 2 illustrates a conversion guide 200 according to one embodiment. The conversion guide 200 is configured to provide a user with the same information as described above with respect to the conversion guide 100. The conversion guide 200 includes a circular-shaped housing 220 and a circular-shaped insert 250 that is rotatably disposed in the housing 220. The housing 220 may include first and second display features 230 and 240 that are configured in a similar manner as the display features of the conversion guide 100. The insert 250 may include first and second measurement ranges 260 and 270 and an indication range 280 provided on the surface of the insert 250 in a similar manner as the ranges provided on the insert 150. The first and second measurement ranges 260 and 270 and the indication range 280 may be provided on the surface of the insert 250 in circular patterns such that a number in first measurement range, its correlated number in the second measurement range, and its corresponding color indicator in the indication range are simultaneously displayed in the first display feature 230. A user may rotate the insert 250 in the housing 220 until a particular hemoglobin A1c value is shown in a first aperture 232. The correlated blood sugar value and corresponding color indicator will be simultaneously displayed in second and third apertures 234 and 236, respectively. The color indicator (or alert level) displayed in the third aperture 236 can then be compared with the corresponding health level warnings 242 provided in the second display feature 240. Using the conversion guide 200, the user may quickly obtain their blood sugar level and a warning about the status of their health based on their hemoglobin A1c level.

The housing and/or the insert of the conversion guides 100 and 200 may be formed from a variety of materials include but not limited to wood/paper based materials, metal based materials, and/or plastic based materials. The indicators and health level warnings provided on the inserts and the housings of the conversion guides 100 and 200 may be communicated using a variety of identification features including but not limited to colors, shapes, images, letters, words, and/or other similar surface indicia. The conversion guides 100 and 200 may be dimensioned so that a user can easily store and carry the conversion guide in a pocket of clothing or a carrying device, such as a wallet, purse, or backpack. In one embodiment, the conversion guides 100 and 200 are configured so that a user can use the conversion guide when viewing either side of the housing and/or insert.

While the foregoing is directed to embodiments of the present invention, other and further embodiments of the invention may be devised without departing from the basic scope thereof, and the scope thereof is determined by the claims that follow.

1. A conversion guide, comprising:
a housing having a plurality of openings disposed through the housing; and
an insert having a first measurement range, a second measurement range, and an indication range provided on a surface of the insert, wherein when the insert is disposed in the housing, a first measurement from the first range, a second measurement from the second range, and an indicator from the indication range are simultaneously viewable through the plurality of openings.

2. The guide of claim 1, wherein the first measurement range includes a range of values that correspond to a hemoglobin A1c level.

3. The guide of claim 1, wherein the second measurement range includes a range of values that correspond to a blood sugar level.

4. The guide of claim 1, wherein the indication range includes a range of color indicators.

5. The guide of claim 1, wherein first measurement is a hemoglobin A1c value, wherein the second measurement is a blood sugar value based on the hemoglobin A1c value, and the indicator is a color identifying a health level warning based on the blood sugar value.

6. The guide of claim 5, wherein the housing includes a health level warning chart provided on a surface of the housing that is configured to communicate a status of health based on the color indicator.

7. The guide of claim 1, wherein the insert is slideably disposed in the housing.

8. The guide of claim 1, wherein the insert is rotatably disposed in the housing.

9. The guide of claim 1, wherein the insert is removable from the housing.

10. A method of calculating a blood sugar level using a conversion guide, comprising:
locating a hemoglobin A1c value on an insert disposed in a housing of the conversion guide;
displaying the hemoglobin A1c value in a first window of the housing; and
displaying a blood sugar value in a second window of the housing simultaneously with the hemoglobin A1c value, wherein the blood sugar value is a calculated value based on the hemoglobin A1c value.

11. The method of claim 10, further comprising displaying an alert level in a third window of the housing simultaneously with at least one of the hemoglobin A1c value and the blood sugar value.

12. The method of claim 11, further comprising comparing the alert level to a health warning level that indicates a status of an individual's health.

13. The method of claim 11, wherein the alert level is a color indicator.

14. The method of claim 11, further comprising providing a range of hemoglobin A1c values on a surface of the insert.

15. The method of claim 11, further comprising providing a range of blood sugar values on a surface of the insert.

16. The method of claim 11, further comprising providing a range of alert levels on a surface of the insert.

17. The method of claim 11, further comprising providing a range of health level warnings on a surface of the housing.

18. The method of claim 10, further comprising sliding the insert relative to the housing to locate the hemoglobin A1c value.

19. The method of claim 10, further comprising rotating the insert relative to the housing to locate the hemoglobin A1c value.

20. The method of claim 10, further comprising inserting the insert into the housing.
